(19) United States
(12) Patent Application Publication
(10) Pub. No.: US 2011/0039101 A1
(43) Pub. Date: Feb. 17, 2011

(54) ELECTROSPUN FIBER TUBULAR MATERIAL AND PREPARATION METHOD THEREOF

(75) Inventors: Jiang Chang, Shanghai (CN); Daming Zhang, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: SHANGHAI INSTITUTE OF CERAMICS, CHINESE ACADEMY OF SCIENCES, Shanghai (CN)

(21) Appl. No.: 12/988,449

(22) PCT Filed: Apr. 20, 2009
(86) PCT No.: PCT/CN09/71348

§ 371 Date: Oct. 18, 2010

(30) Foreign Application Priority Data
Apr. 18, 2008 (CN) 200810036279.3

(51) Int. Cl. D01D 5/00; D02G 3/00; B29C 47/00

(52) U.S. Cl. 428/398; 264/465

(57) ABSTRACT

A method of preparing electrospun fiber tubular material comprises: using single metal rod template or two-dimensional or three-dimensional metal rod combined-template which has cross structure and is composed of the said single metal rod templates to prepare tubular electrospun fiber material by controlling electrospinning process parameters. The method could control the macro-structure and micro-structure of the tubular electrospun fiber material by adjusting template parameters. The tubular electrospun fiber material obtained from the method could be used in such fields as biomedical material, tissue engineering scaffold, photo-electric material, filtering material and sensor etc.

### TECHNICAL FIELD

The invention relates to a process for preparing electrospun fiber tubular material using electrospinning technology and particular collecting template, and to electrospun fiber tubular material prepared with the same. The invention belongs to the field of electrospun fiber tubular material.

### BACKGROUND ART

Along with the industrial development and technological advancement, electrospinning technology is gaining more and more attention. As a simple and effective process for preparing nano-/micro-scale fiber materials, electrospinning has been widely used in such fields as biomedical materials, tissue engineering, photoelectric materials, filtering materials, sensors and the like. Electric technology involves formation of a jet from a solution or melt of a polymer or other material in high-voltage electric field, ejection of the jet from a solution-storing unit during which the solvent evaporates and the jet solidifies, and finally deposition of the solidified jet on a receiving unit to form nano-/micro-scale fiber assemblage.

Tubular fiber materials have been widely used in biomedical and certain industrial fields, and still have promising prospect of further development, especially in tissue engineering such as blood vessels, nerves, etc., where tubular fiber materials play a vital role as scaffold materials. Tissue engineering imposes certain demands on the macro-configuration and micro-morphology of three-dimensional tubular fiber materials in practical use. For example, for a particular organ or tissue, certain tubular fiber materials with particular macro-configuration and size are needed to fit the contour of the organ or tissue. On the other hand, certain tubular fiber materials with particular micro-morphology are needed to facilitate the adherence and differentiation of particular cells. For different organs or tissues, besides a network of tubular fiber material having a structure of communicating channels as required by blood vessel tissue engineering, the angle, number, size, etc. of channel furcation(tube furcation) vary according to practical demand. Therefore, preparation of tubular fiber materials with controllable macro-configuration and micro-morphology is of great significance in biological tissue engineering and a variety of industrial applications. Generally, tubular fiber materials of certain size may be collected controlling electrospinning process parameters and a roller assembly. However, both macro-configuration and micro-morphology thereof are limited to some extent. For example, due to the limitation of the roller assembly, controllable macro-configuration can not be achieved in terms of the size, tube end closure, etc. of the tubular fiber material. On a micro scale, fibers are generally arranged randomly or oriented to the degree only along the circumference, and no complex and controllable micro-morphology can be formed in a controllable way. In addition, conventional processes are just limited to the preparation of a single-channel structure, unable to produce electrospun fiber materials having a structure of complex communicating channels, letting alone control of the complex channel structure. Thus, it is still blank up to date in the area of preparing three-dimensional tubular fiber material with controllable macro-configuration and micro-morphology using electrospinning.

### SUMMARY OF THE INVENTION

The object of the invention is to provide a process for preparing electrospun fiber tubular material as well as electrospun fiber tubular material prepared using the same, wherein the process comprises the following specific steps:
(1) formulating a solution or melt for the electrospinning process, wherein the solution or melt for the electrospinning process is known to those skilled in the art; particularly, the formulation method may be any reported conventional electrospinning process; the material used to prepare the solution or melt may be a polymer, inorganic material or composite material; and there is no limitation on the material on condition that it does not limit the object of the invention;
(2) loading the solution or melt into an electrospinning fluid supplying unit, wherein the solution or melt may be alternatively formulated in the electrospinning fluid supplying unit directly as known to those skilled in the art;
(3) immobilizing one or more metal rod templates or a metal rod combined-template, as a collecting unit, on an auxiliary planar substrate connected with a low-voltage earth terminal, wherein the collecting unit may be assembled according to any conventional method in the art of electrospinning; the object of the invention may also be achieved by only using the template without the use of any auxiliary planar substrate; the template may be solid or hollow; and in the case of being hollow, there is no limitation on the shape and size of the template on condition that the outer wall of the template is kept intact;
(4) controlling the flow rate of the electrospinning solution or melt in the range of 0.1-300 ml/h, the distance between the spinneret as the high-voltage terminal and the collecting unit in the range of 1-100 cm, and the voltage provided by the high voltage generator during electrospinning in the range of 1-80 kv;
(5) collecting the electrospun fiber tubular material on the metal rod templates or the metal rod combined-template and removing it therefrom.

The electrospinning fluid supplying unit (including the spinneret therein), the high voltage generator and the low-voltage earth terminal may be arranged according to any conventional method in the art of electrospinning.

The metal rod template or the metal rod combined-template includes:
(1) a single metal rod template; and
(2) a two-dimensional or three-dimensional metal rod combined-template having an intersecting structure(cross structure) which is formed by combining single metal rod templates, wherein the intersecting angel lies between 10°-90°, and more than two single metal rod templates are combined.

The two-dimensional or three-dimensional metal rod combined-template may be designed to be a disassemble or undisassemble collecting template.

The surface of a removable singe metal rod template may be designed to have a hole compatible with the size of a secondary removable template. The hole may be an intersecting through-hole or closed at one end. Single metal rod templates may be combined by intersecting one another in different directions.

The single metal rod template, including those in the two-dimensional or three-dimensional metal rod combined-template, has the following features or a combination thereof:
(1) The metal material used in the single metal rod template may be conductive metal material and conductive metal alloy material, including copper, iron, aluminum and alloys thereof.
(2) The single metal rod template may be column-shaped or noncolumn-shaped or a combination thereof, such as a taper, a combination of columns of various sizes, a combination of a taper and a column, etc.
(3) The length of the single metal rod template may be tailored in the range of 0.5-50 cm. Adjustment may be made by those skilled in the art according to practical need. For example, a length in the range of 0.05-0.5 cm is permitted for a template. A preferred length is in the range of 0.5-30 cm.
(4) The cross-sectional shape of the single metal rod template may be any regular or irregular shape, such as triangle, square, rectangle, pentacle, circle, etc.
(5) The size of the cross-section of the single metal rod template may be in the range of 0.005-30 cm based on the circumcircle diameter of the cross-section.
(6) The surface of the single metal rod template may be smooth or have a particularly patterned microstructure, wherein the particularly patterned microstructure is a grid collecting structure or a raised collecting structure.

The grid collecting structure is formed by weaving grid wires of various radial sizes using various weaving methods. The radial size of the grid wires is in the range of 0.1-5 mm, and the space between the grid wires is in the range of 10-1000 μm. The grid may be woven in a series of different ways such as single weaving, double weaving and the like.

The raised portion of the raised collecting structure comprises protrusions on the surface of the single metal rod template. The height of the protrusions may be tailored in the range of 10-5000 μm. The raised portion may be designed to form raised dot collecting template (the protrusions are composed of dots with a combination of shapes such as square, rectangle, circle, star, etc.), raised line collecting template (the protrusions are lines, i.e. composed of a combination of straight lines, arc lines and line segments) and raised dot-line collecting template (the protrusions are composed of a combination of dots and lines of various shapes). The non-raised portion may be conductive or insulating.

According to the process of the invention, the metal rod template or the metal rod combined-template as described above may be used successfully to prepare a series of nano-/micro-scale tubular fiber materials with controllable macro-configuration and micro-morphology, comprising:
(1) single tubular fiber materials; and
(2) two-dimensional or three-dimensional tubular fiber materials having a structure of communicating and intersecting channels, wherein the intersecting angle lies between 10°-90°; the communicating structure of the channels in the fiber assemblage may be a thoroughly communicating structure such as crisscross-shaped and X-shaped structure, or a structure which is open at one end and closed at the other, such as T-shaped structure and Y-shaped structure; and various amounts of tubular fiber materials may be combined to form different two-dimensional and three-dimensional network structures.

The single tubular fiber material, including those in the two-dimensional or three-dimensional tubular fiber materials having a structure of communicating and intersecting channels, has one or a combination of the following features:
(1) The single tubular fiber material may be a polymeric, inorganic or composite material.
(2) The single tubular fiber material may have a shape of column-shaped channel, non-column-shaped channel or a combination of column-shaped and non-column-shaped channel, such as a three-dimensional channel configuration of taper, a combination of columns of various sizes, a combination of a taper and a column, etc.
(3) The single tubular fiber material may have a length in the range of 0.5-50 cm, dependent on the length of the template. In other words, a length in the range of 0.05-0.5 cm is also permitted. The preferred length is in the range of 0.5-30 cm.
(4) The cross-sectional shape of the single tubular fiber material may be any regular or irregular shape, such as triangle, square, rectangle, pentacle, circle, etc.
(5) The size of the cross-section of the single tubular fiber material may be in the range of 0.005-30 cm based on the circumcircle diameter.
(6) The surface morphology of the single tubular fiber material may be an unorderly non-woven structure, or have a particularly patterned microstructure.

Compared with conventional collecting methods in electrospinning, the process of the invention provides unexpected results by designing and using the collecting templates as described above, which may be explained by way of the following mechanism. During electrospinning, fiber is forced by the high-voltage field to move toward the collecting template. Wherever the structure of the collecting template changes, the direction of the electric field force changes accordingly to redirect the fiber toward the surface of the three-dimensional collecting template. In this electric field with varying direction, the fiber is deposited on the surface of the collecting template from different directions to form a tubular fiber material rather than only on a planar template as in conventional electrospinning to form a two-dimensional thin film.

At the same time, a planar auxiliary substrate and a rod-like auxiliary template (especially the latter) are incorporated into the invention to diversify the deposition routes of the electrospun fibers, successfully avoiding both concentrated deposition of fibers on the top of the three-dimensional collecting template and suspension of fibers from the root of the three-dimensional collecting template. As a result, the structural integrity and uniformity of the three-dimensional tubular fiber material are enhanced effectively (see FIG. 1). Specifically, as a fiber approaches the collecting template under the electric field force, the electrostatic charges on the fiber surface will induce opposite charges to the collecting template. The attraction between unlike charges brings about Coulomb force therebetween. Since Coulomb force is inversely proportional to the square of the distance between charges (F=kqQ/r², wherein F represents Coulomb force, and r represents the distance between two unlike charges, i.e. the space between a fiber and the collecting template), and a fiber segment is more close to an adjacent protrusion than to the other area of the template, the fiber prefers to deposit on the protrusion under the relatively larger Coulomb force therebetween. Different segments of a fiber may be attracted by different protrusions, so that the fiber may deposit on and thus is suspended between different protrusions. The suspended fiber is drawn by Coulomb forces from different directions into an oriented arrangement between protrusions.

The features of the invention include:
(1) The three-dimensional configuration of the fiber material may be controlled by the macro-configuration of the single three-dimensional collecting template. The fiber mainly deposit on the surface of the three-dimensional collecting template. The macro-configuration of the tubular fiber material closely resembles and is mainly determined by the contour configuration of the three-dimensional collecting template.
(2) The deposition position and arrangement pattern may be controlled by the patterned microstructure on the collecting template surface. Fibers are mainly deposited on protrusions, and fibers suspended between protrusions feature well-oriented arrangement.
(3) The three-dimensional communicating channel structure of the fiber material may be controlled by the way in which removable three-dimensional collecting templates are combined and the network structure thus formed. The fibers mainly deposit on the surface of the combined disassemble three-dimensional collecting templates. The communicating channel structure of the fiber material closely resembles and is mainly determined by the network structure of the three-dimensional collecting template.
(4) Several electrospun fiber tubular materials having the same or different macro-configurations and patterned microstructures may be prepared concurrently by batch production of combined templates.

According to the invention, while making use of conventional electrospinning technology and suitable starting materials and processes, electrospun fiber tubular material with controllable macro-configuration and micro-morphology has been prepared by designing and using a collecting template with controllable macro-configuration and micro-morphology. Furthermore, the structure and morphology of the tubular material may be controlled by designing the macro-configuration and patterned microstructure of the template. Thus, the practical application of electrospinning is more promising, especially in the field of biomedical material, tissue engineering, photoelectric material, filtering material, sensors, etc. which have higher demand on material morphology.

### BRIEF DESCRIPTION OF THE DRAWINGS

FIG. 1 is a schematic view showing the operational principles of electrospinning and the three-dimensional collecting template according to the invention, wherein 1 represents a high voltage generator and controller, 2 represents a flow rate controlling pump, 3 represents an electrospinning solution or melt supplying unit, 4 represents a spinneret of electrospinning, 5 represents electrospun fiber tubular material, 6 represents a rod-like template, and 7 represents a planar auxiliary substrate.

FIG. 2 is a schematic view showing several column-shaped collecting templates having different three-dimensional configurations.

FIG. 3 is an optical photo of side view showing the electrospun fiber tubular materials of different diameters as obtained according to Example 1.

FIG. 4 is an optical micrograph of top view showing the electrospun fiber tubular materials of different diameters as obtained according to Example 1, wherein the insertion is a magnified SEM image of the electrospun fiber tubular materials.

FIG. 5 is an optical photo showing the electrospun fiber tubular material having a longer length as obtained according to Example 2.

FIG. 6 is an optical photo showing the electrospun fiber tubular materials having different cross-sectional shapes as obtained according to Example 3.

FIG. 7 is an optical photo showing the electrospun fiber tubular materials with one end closed as obtained according to Example 4.

FIG. 8 is a schematic view showing several non-column-shaped collecting templates having different three-dimensional configurations.

FIG. 9 is an optical photo showing the electrospun fiber tubular materials having different configurations as obtained according to Example 5.

FIG. 10 is a schematic view showing a three-dimensional collecting template having a patterned microstructure on its surface.

FIG. 11 is an optical photo showing the electrospun fiber tubular material having a patterned micro-morphology as obtained according to Example 6.

FIG. 12 is a SEM image showing the electrospun fiber tubular material having a patterned micro-morphology as obtained according to Example 6.

FIG. 13 is an optical photo showing the three-dimensional electrospun fiber tubular material having two different patterned micro-morphologies as obtained according to Example 7.

FIG. 14 is an optical photo showing one of the patterned micro-morphologies in the three-dimensional electrospun fiber tubular material as obtained according to Example 7.

FIG. 15 is an optical photo showing the other patterned micro-morphology in the three-dimensional electrospun fiber tubular material as obtained according to Example 7.

FIG. 16 is a schematic view showing a three-dimensional collecting template having four patterned microstructures on its surface.

FIG. 17 is an optical photo showing the three-dimensional electrospun fiber tubular material having four different patterned micro-morphologies as obtained according to Example 8.

FIG. 18 is an optical photo showing the unfolded three-dimensional electrospun fiber tubular material having four different patterned micro-morphologies as obtained according to Example 8.

FIG. 19 is a schematic view showing the specific experimental steps for preparing a three-dimensional electrospun fiber material having a communicating channel structure controlling electrospinning process parameters and a disassembble three-dimensional combined collecting template.

FIG. 20 is a schematic view showing the disassembble three-dimensional combined collecting templates having different intersecting structure(cross structure)s according to Examples 9-12.

FIG. 21 is an optical photo showing the three-dimensional electrospun fiber material having a crisscross-shaped intersecting and communicating channel structure as obtained according to Example 9.

FIG. 22 is an optical photo showing the three-dimensional electrospun fiber material having a T-shaped intersecting channel structure as obtained according to Example 10.

FIG. 23 is an optical photo showing the three-dimensional electrospun fiber material having an X-shaped intersecting channel structure as obtained according to Example 11.

FIG. 24 is an optical photo showing the three-dimensional electrospun fiber material having a Y-shaped intersecting channel structure as obtained according to Example 12.

FIG. 25 is a schematic view showing the disassemble three-dimensional combined collecting template having various intersecting structure(cross structure)s according to Examples 13.

FIG. 26 is a schematic view showing the three-dimensional electrospun fiber material having two branch channels of different configurations connected to the same primary channel as obtained according to Example 13.

FIG. 27 is a schematic view showing the disassemble three-dimensional combined collecting template having a complex intersecting network structure according to Examples 14.

FIG. 28 is a schematic view showing the three-dimensional electrospun fiber material having a complex channel network structure as obtained according to Example 14.

FIG. 29 is an optical photo showing the three-dimensional electrospinning fiber tubular materials as batch-produced according to Example 15 along with the collecting templates.

FIG. 30 is an optical photo showing the three-dimensional electrospun fiber tubular materials as batch-produced according to Example 15.

FIG. 31 is a schematic view showing the batch production of three-dimensional electrospinning fiber tubular materials according to Example 16.

FIG. 32 is a schematic view showing the templates of three-dimensional electrospinning fiber tubular materials according to Example 17.

FIG. 33 is a schematic view showing the Y-shaped templates of three-dimensional electrospinning fiber tubular materials according to Example 18.

FIG. 34 is a schematic view showing the three-dimensional electrospinning fiber tubular materials as batch-produced according to Example 20 along with the collecting templates.

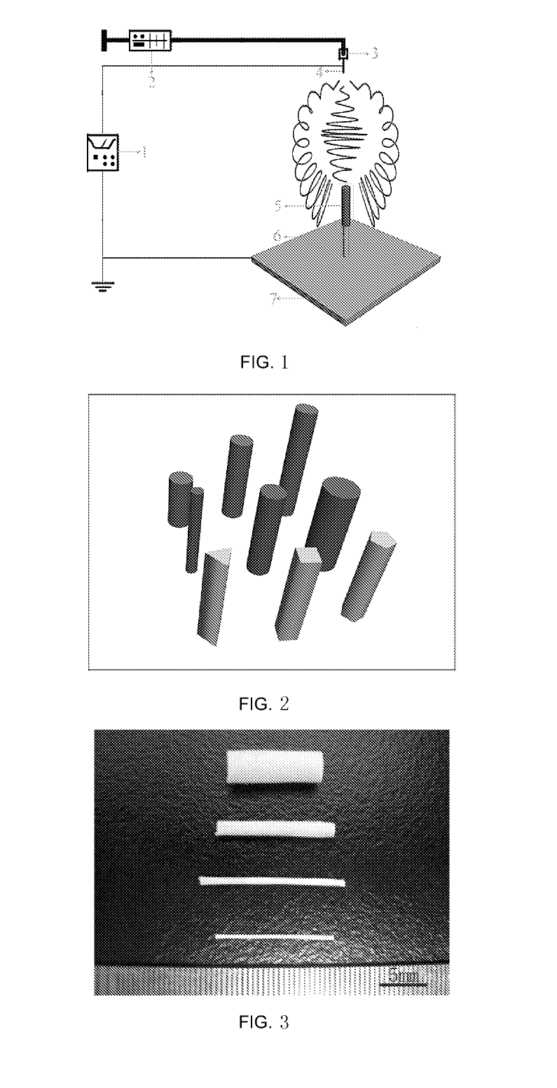

### DETAILED DESCRIPTION OF THE INVENTION

The invention will be illustrated with reference to the following examples but is not limited thereto.

### Example 1

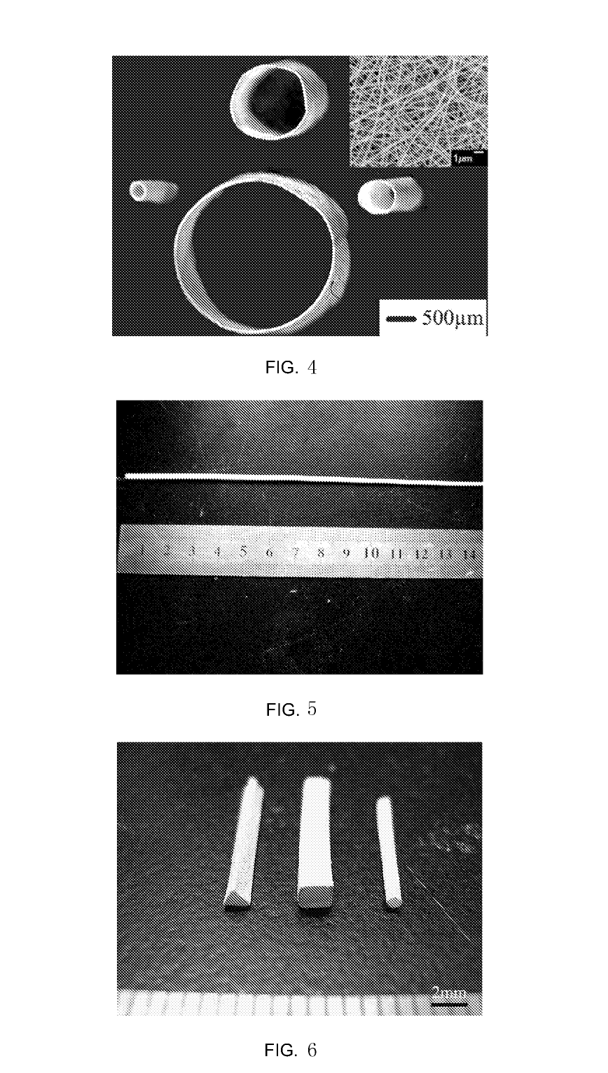

A group of cylindrical copper rods with different diameters, namely 0.18 mm, 0.50 mm, 1.36 mm and 3.28 mm, were prepared as three-dimensional templates. This group of cylindrical templates were selected as the collecting substrates for electrospinning. 2 g polycaprolactone (PCL, Mw=5 w) was dissolved in 6 ml N,N-dimethyl formamide (DMF) and 4 ml tetrahydrofuran (THF), and agitated at room temperature to form a homogenous and stable solution. The solution was infused into an injector, the head of which was connected to a high-voltage electric source and used as the high-voltage terminal. The flow rate of the solution was controlled at 0.5 ml/h by a flow rate pump. The applied voltage was 10 kv. The distance(or space) between the high-voltage terminal and the collecting unit was 10 cm. Three-dimensional electrospinning fiber tubular materials, having similar structures to those of the substrates and different diameters, were collected in this process (FIGS. 2-4), wherein the tube diameters were 0.18 mm, 0.50 mm, 1.36 mm and 3.28 mm respectively, and their lengths were 1 cm, 1.3 cm, 1.5 cm and 1.3 cm respectively.

### Example 2

A cylindrical copper wire having a relatively longer length was prepared as a three-dimensional template. The copper wire had a diameter of 0.50 mm and a length of 15 cm. The other parameters were the same as those in Example 1. A three-dimensional electrospinning fiber tubular material, having a similar structure to that of the substrate and a relatively longer length, was collected in this process (FIGS. 2 and 5), wherein the tube diameter was 0.50 mm, and its length was 15 cm.

### Example 3

A group of column-shaped copper rods having different cross-sectional shapes, namely triangle, square and cylinder, were prepared as three-dimensional templates. This group of column-shaped templates were selected as the collecting substrates for electrospinning. The other parameters were the same as those in Example 1. Three-dimensional electrospinning fiber tubular materials, having similar structures to those of the substrates and different cross-sectional shapes, were collected in this process (FIGS. 2, 6), wherein the tube length was 2 cm.

### Example 4

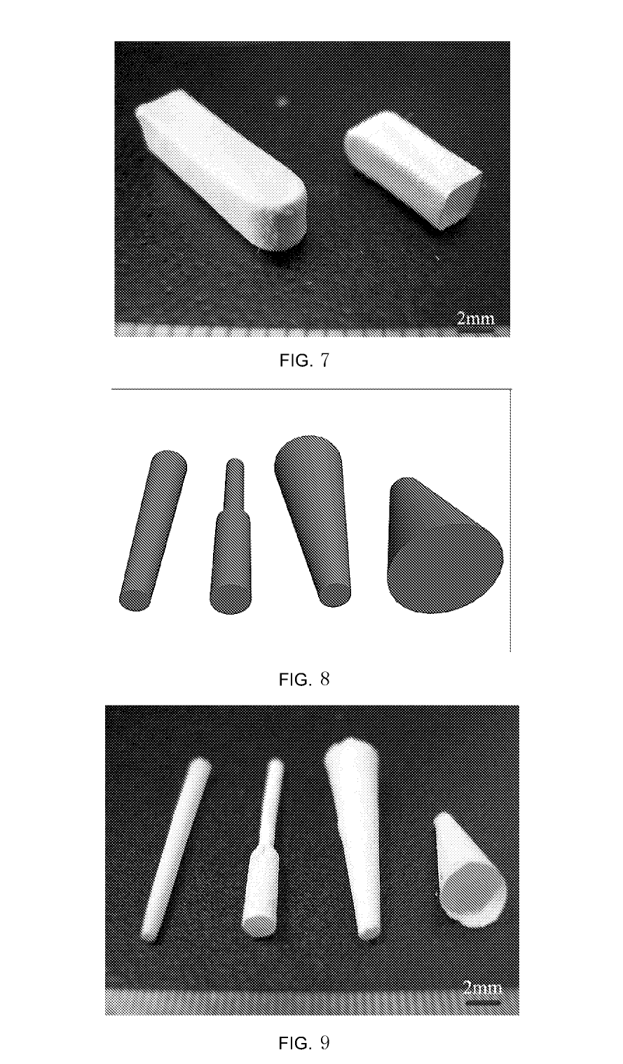

A group of column-shaped copper rods having one arc-shaped end were prepared as three-dimensional templates. The copper rods had square cross-sections with a side length of 2 mm. This group of column-shaped templates were selected as the collecting substrates for electrospinning. The templates was arranged with the arc-shaped end upward, in proximate to the spinneret. The other parameters were the same as those in Example 1. After spinning, each of the collecting copper rods was pulled out from the non-arc end, so that the structure of the fiber assemblage at the arc end was not impaired. Three-dimensional electrospinning fiber tubular materials, having similar structures to those of the substrates and one closed end, were collected in this process (FIG. 7), wherein the tube lengths were 1.5 cm and 2 cm.

### Example 5

A group of non-column-shaped copper rods having different configurations were prepared as three-dimensional templates. The copper rods were tapers of different taper degrees, or had a combination of cylinders with different diameters at different locations. The other parameters were the same as those in Example 1. After spinning, each of the collecting copper rods was pulled out from the non-arc end, so that the structure of the fiber assemblage at the arc end was not impaired. Three-dimensional electrospinning fiber tubular materials, having similar structures to those of the substrates and different cross-sectional sizes at different locations, were collected in this process (FIGS. 8, 9), wherein the tube length was 2 cm.

### Example 6

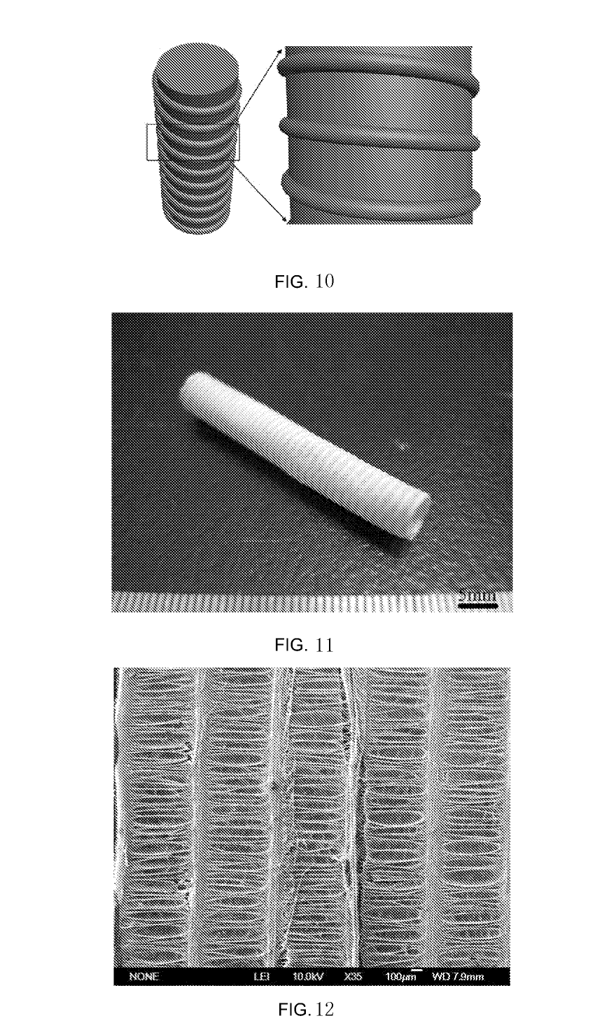

A column-shaped copper rod having patterned microstructure of annular line protrusions on its surface was prepared as a three-dimensional template. The copper rod had a circular cross-section with a diameter of 5 mm, and the space between protrusions was 0.5 mm. This column-shaped template was selected as the collecting substrate for electrospinning. 0.275 g polylactic acid (PDLLA, Mw=45 kDa) was dissolved in 8 ml N,N-dimethyl formamide (DMF) and 2 ml tetrahydrofuran (THF), and agitated at room temperature to form a homogenous and stable solution. The solution was infused into an injector, the head of which was connected to a high-voltage electric source and used as the high-voltage terminal. The flow of the solution was controlled at 0.5 ml/h by a flow rate pump. The applied voltage was 10 kv. The space between the high-voltage terminal and the collecting unit was 10 cm. A three-dimensional electrospinning fiber tubular material, having a similar structure to that of the substrate and a patterned microstructure, was collected in this process (FIGS. 10-12), wherein the tube diameter was 4 mm, and its length was 5 cm.

### Example 7

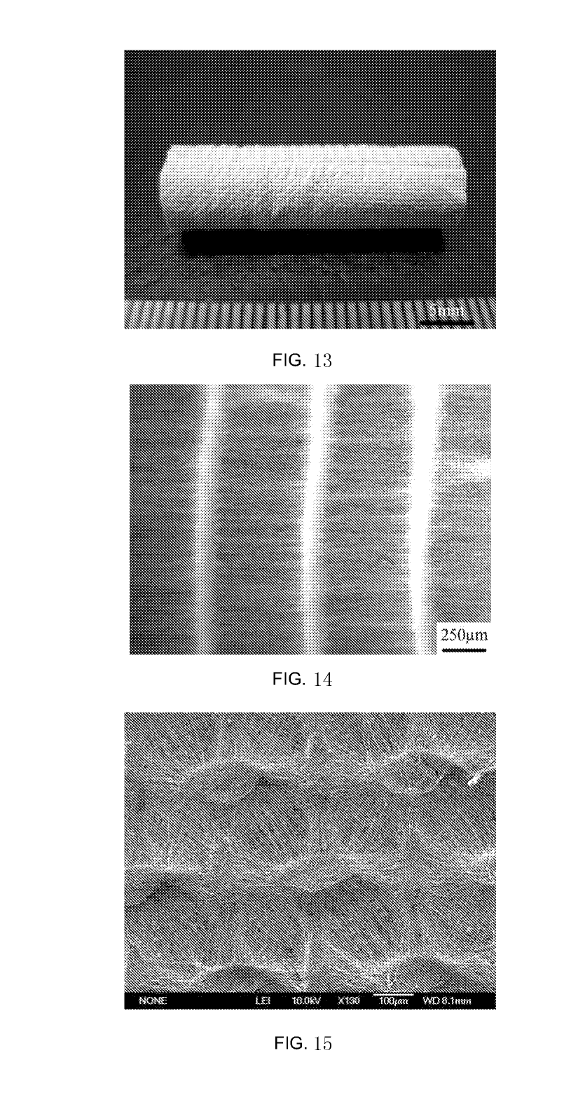

A column-shaped copper rod having two different patterned microstructures on its surface was prepared as a three-dimensional template. One of the micropatterns was a structure comprising annular line protrusions, wherein the space between the protrusions was 0.5 mm. The other micropattern was a woven grid structure, wherein the grid line had a diameter of 0.1 mm, and the space between the lines was 0.14 mm. The copper rod had a circular cross-section with a diameter of 5 mm. This column-shaped template was selected as the collecting substrate for electrospinning. The other parameters were the same as those in Example 1. A three-dimensional electrospinning fiber tubular material, having a similar structure to that of the substrate and two patterned microstructures, was collected in this process (FIGS. 13-15), wherein the tube length was 1.5 cm.

### Example 8

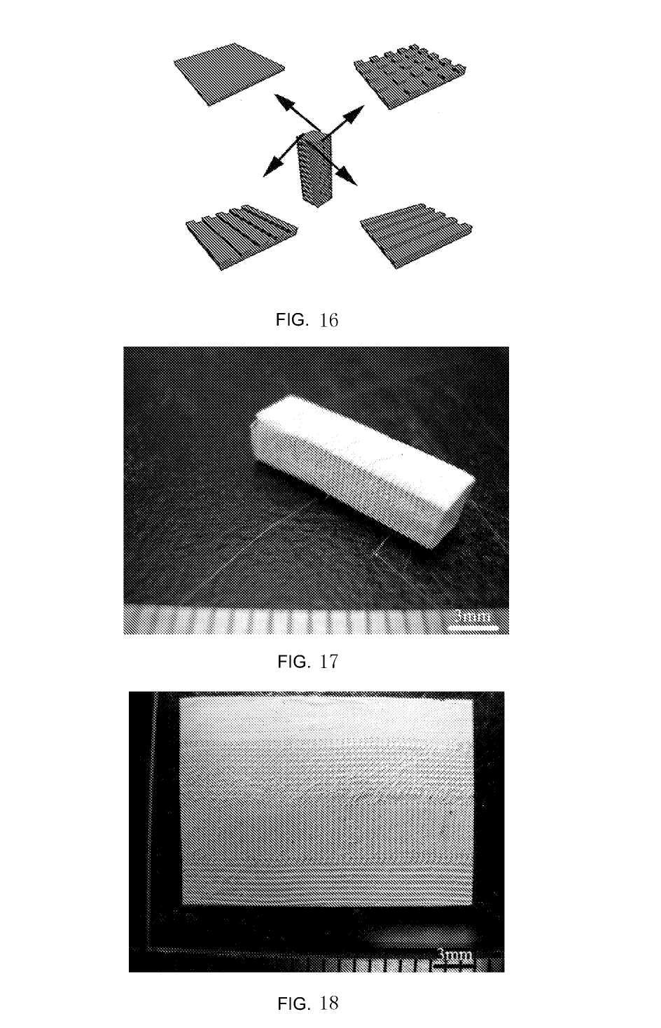

A column-shaped copper rod having four different patterned microstructures on its surface was prepared as a three-dimensional template. The first micropattern was a structure of smooth flat plate. The second micropattern was a structure comprising square dot protrusions arranged orderly, wherein the side length of each protrusion and the space between the protrusions were both 0.2 mm. The third micropattern was a structure comprising straight line protrusions, wherein the width of each protrusion and the space between the protrusions were both 0.2 mm, and the line protrusions were parallel to the axis of the three-dimensional column-shaped template. The fourth micropattern was a structure comprising straight line protrusions, wherein the width of each protrusion and the space between the protrusions were both 0.2 mm, and the line protrusions were perpendicular to the axis of the three-dimensional column-shaped template. The copper rod had a square cross-section with a diameter of 3 mm. This column-shaped template was selected as the collecting substrate for electrospinning. The other parameters were the same as those in Example 1. A three-dimensional electrospinning fiber tubular material, having a similar structure to that of the substrate and four patterned microstructures, was collected in this process (FIGS. 16-18).

### Example 9

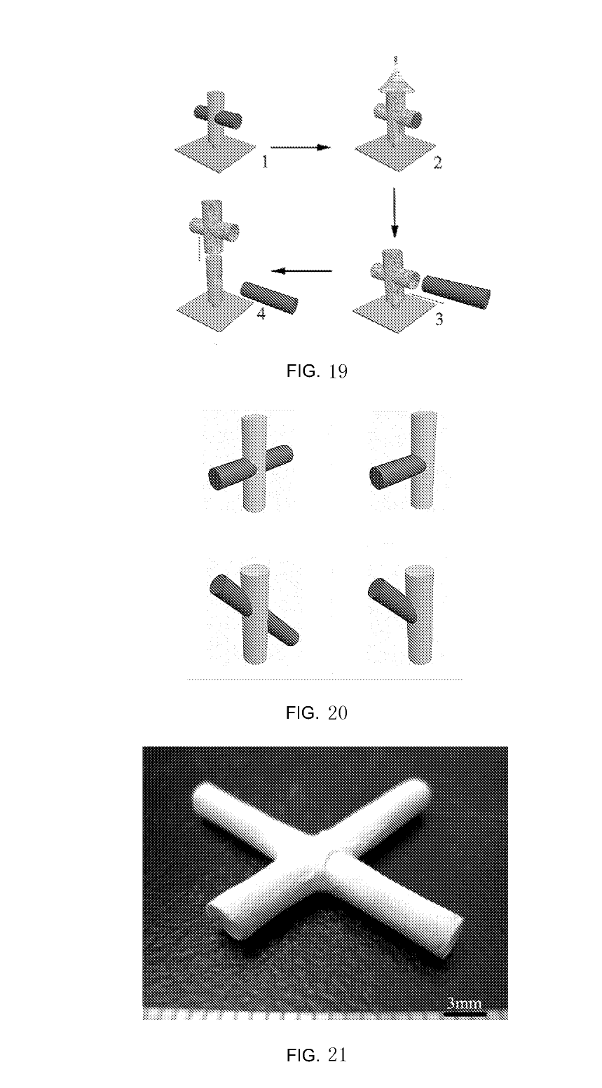

A whole cylindrical copper rod was prepared as a removable three-dimensional collecting template with a diameter of 3 mm. Another cylindrical copper rod with a through-hole (having a size compatible with the above template) was prepared as a fixed collecting template with a diameter of 4 mm. These two templates were assembled in a perpendicularly intersecting relationship to form a disassemble three-dimensional combined collecting template. This combined template was selected as the collecting substrate for electrospinning. The other parameters were the same as those in Example 1.Specific experimental steps were as follows (FIG. 19): (1) assembling the two individual templates into a disassemble three-dimensional combined collecting template before electrospinning and collection; (2) depositing the fiber on the template surface during electrospinning to form electrospun fiber material having a similar structure to that of the substrate and perpendicular communicating channels; (3) pulling out the removable template first after collection; and then (4) removing the three-dimensional electrospun fiber material from the fixed template. A three-dimensional electrospun fiber material, having a similar structure to that of the substrate and crisscross-shaped intersecting and communicating channels, was collected in this process (FIGS. 20, 21).

### Example 10

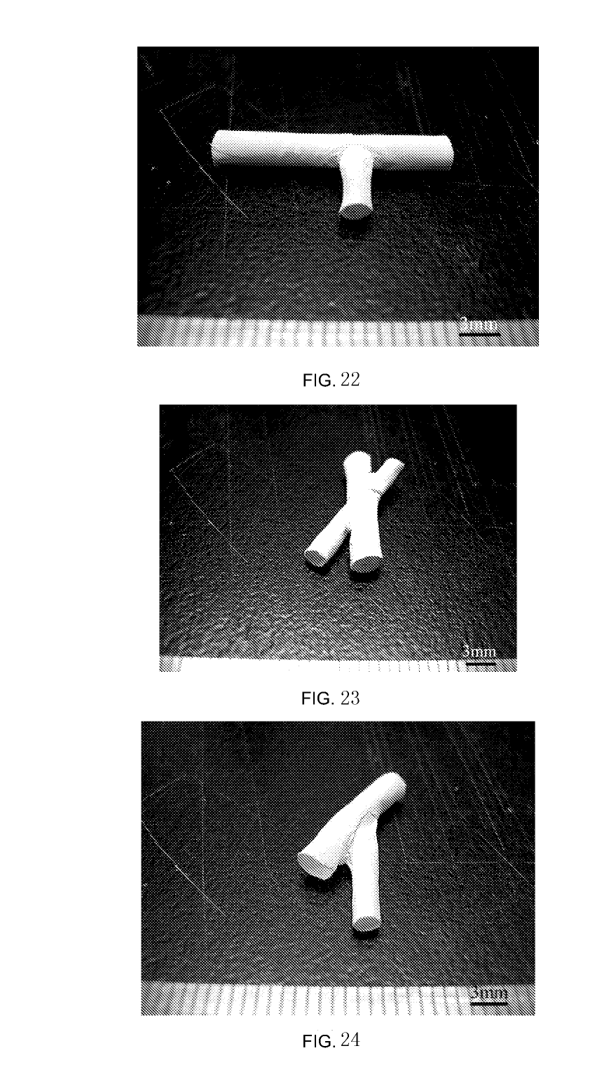

A whole cylindrical copper rod was prepared as a removable three-dimensional collecting template with a diameter of 3 mm. Another cylindrical copper rod with a hole (having a size compatible with the above template) closed at one end was prepared as a fixed collecting template with a diameter of 4 mm. These two templates were assembled in a perpendicularly intersecting relationship to form a disassemble three-dimensional combined collecting template. This combined template was selected as the collecting substrate for electrospinning. The other parameters were the same as those in Example 1. The specific steps for moving and removing the electrospinning fiber tubular material were the same as those in Example 9. A three-dimensional electrospun fiber material, having a similar structure to that of the substrate and T-shaped intersecting channels, was collected in this process (FIGS. 20, 22).

### Example 11

A whole cylindrical copper rod was prepared as a removable three-dimensional collecting template with a diameter of 3 mm. Another cylindrical copper rod with a through-hole (having a size compatible with the above template) was prepared as a fixed collecting template with a diameter of 4 mm. These two templates were assembled at an intersecting angle of 30° to form a disassemble three-dimensional combined collecting template. This combined template was selected as the collecting substrate for electrospinning. The other parameters were the same as those in Example 1. The specific steps for moving and removing the electrospinning fiber tubular material were the same as those in Example 9. A three-dimensional electrospun fiber material, having a similar structure to that of the substrate and X-shaped intersecting channels, was collected in this process (FIGS. 20, 23).

### Example 12

A whole cylindrical copper rod was prepared as a removable three-dimensional collecting template with a diameter of 3 mm. Another cylindrical copper rod with a hole (having a size compatible with the above template) closed at one end was prepared as a fixed collecting template with a diameter of 4 mm. These two templates were assembled at an intersecting angle of 30° to form a disassemble three-dimensional combined collecting template. This combined template was selected as the collecting substrate for electrospinning. The other parameters were the same as those in Example 1. The specific steps for moving and removing the electrospinning fiber tubular material were the same as those in Example 9. A three-dimensional electrospun fiber material, having a similar structure to that of the substrate and Y-shaped intersecting channels, was collected in this process (FIGS. 20, 24).

### Example 13

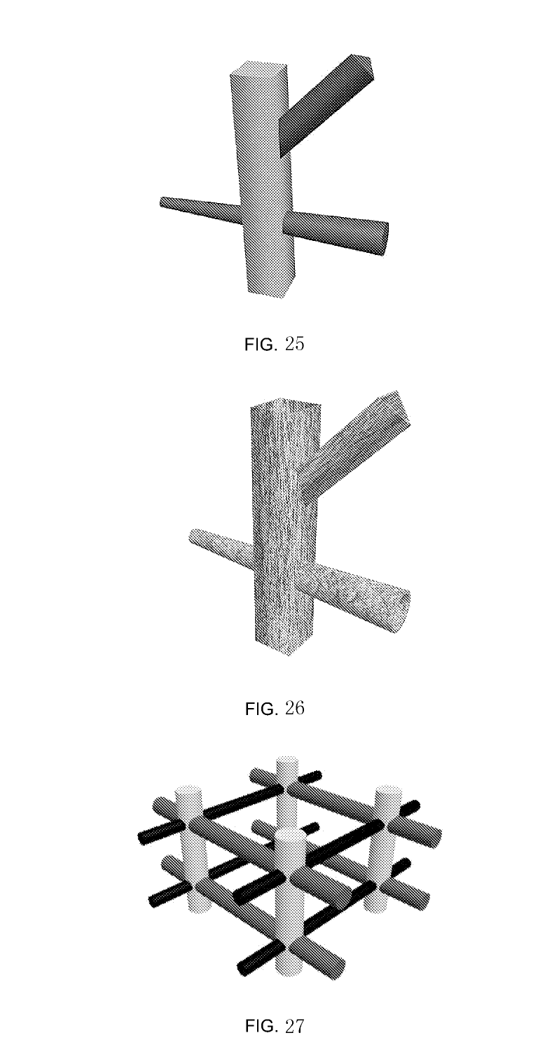

A whole triangular prism copper rod and a whole cone copper rod were prepared as removable three-dimensional collecting templates. A square prism copper rod with both a hole closed at one end and a through-hole was prepared as a fixed collecting template. The three templates were assembled at intersecting angles of 30° and 90° to form a disassemble three-dimensional combined collecting template. This combined template was selected as the collecting substrate for electrospinning. 1.1 g polysuccinate (PBSu, Mw=30 w) was dissolved in 10 ml chloroform (CHCl₃), and agitated at room temperature to form a homogenous and stable solution. The solution was infused into an injector, the head of which was connected to a high-voltage electric source and used as the high-voltage terminal. The flow of the solution was controlled at 5.0 ml/h by a flow rate pump. The applied voltage was 60 kv. The space between the high-voltage terminal and the collecting unit was 25 cm. The specific steps for moving and removing the electrospinning fiber tubular material were the same as those in Example 9. A three-dimensional electrospun fiber material, having a similar structure to that of the substrate and two branch channels of different configurations connected to the same primary channel, was collected in this process (FIGS. 25, 26).

### Example 14

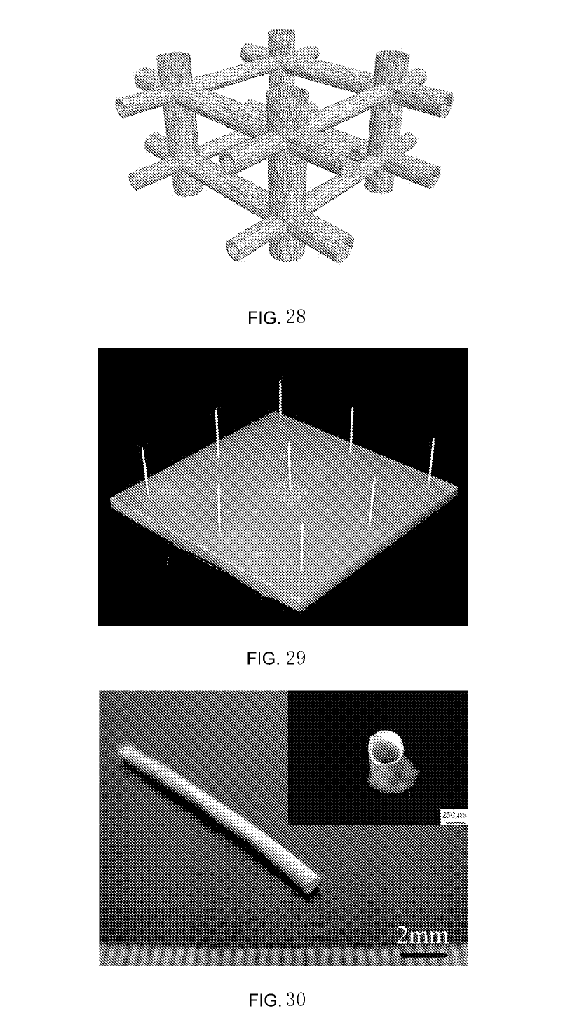

Cylindrical copper rods of different sizes were prepared as single collecting templates, and they were assembled perpendicularly to each other to form a disassemble three-dimensional combined collecting template. This combined template was selected as the collecting substrate for electrospinning. 0.5 ml 1 mol/l hydrochloric acid was added to 50 ml dry ethanol, and then 6.7 g tetraethyl orthosilicate (TEOS), 0.58 g triethyl phosphate (TEP) and 1.48 g calcium nitrate tetrahydrate were added to the solution. After 2 hours of agitation, 5 ml of the resultant sol was added to 5 ml ethanol solution of 1 g polyvinylpyrrolidone (PVP, Mw=3 w) and 0.4 g P123. The resultant solution was agitated for 2 hours and left for later use. The solution was infused into an injector, the head of which was connected to a high-voltage electric source and used as the high-voltage terminal. The flow of the solution was controlled at 0.1 ml/h by a flow rate pump. The applied voltage was 5 kv. The space between the high-voltage terminal and the collecting unit was 2.5 cm. The specific steps for moving and removing the electrospinning fiber tubular material were the same as those in Example 9. A three-dimensional electrospun fiber material, having a similar structure to that of the substrate and a complex channel network structure, was collected in this process (FIGS. 27, 28). Then this product was sintered to give tubular inorganic bioglass fiber material (FIGS. 27, 28).

### Example 15

A three-dimensional combined collecting template was prepared for batch production, wherein each individual template was a cylindrical three-dimensional template with a diameter of 0.5 mm and a height of 2 cm. Nine identical individual templates were immobilized on an insulating plate, wherein the space between the templates was 4 cm. The other parameters were the same as those in Example 1. Nine three-dimensional electrospinning fiber tubular materials, each having a similar structure to that of the substrate, were collected in this process (FIGS. 29, 30). The tubes had a diameter of 0.5 mm and a length of 1.5 cm.

### Example 16

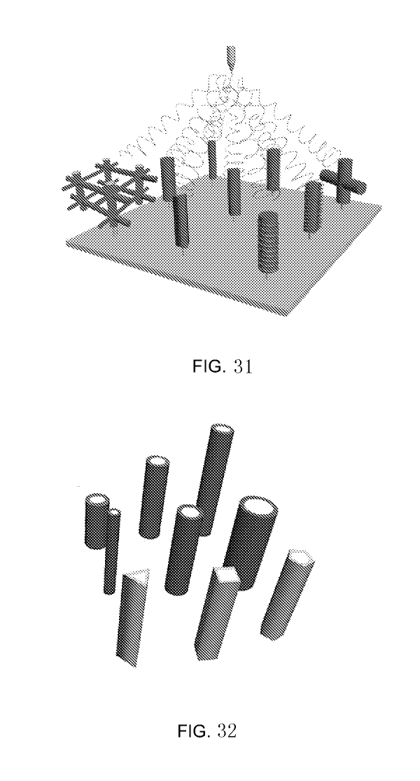

A three-dimensional combined collecting template was prepared for batch production, wherein the individual templates were single collecting templates having different macro-structures and micro-morphologies and disassemble collecting templates having intersecting structure(cross structure)s respectively. Nine individual templates were immobilized on an insulating plate, wherein the space between the templates was 4 cm. 0.1 g wollastonite nanowhisker was first dissolved in 10 ml chloroform (CHCl₃), dispersed evenly by ultrasound, added with 1.1 g polysuccinate (PBSu, Mw=30 w), and then agitated at room temperature to form a homogenous and stable solution. The organic/inorganic composite solution was infused into an injector, the head of which was connected to a high-voltage electric source and used as the high-voltage terminal. The flow of the solution was controlled at 25.0 ml/h by a flow rate pump. The applied voltage was 75 kv. The space between the high-voltage terminal and the collecting unit was 60 cm. Nine organic/inorganic composite tubular fiber materials, each having a similar structure to that of its substrate, were collected in this process (FIG. 31). Each single tube had a diameter (circumcircle diameter) of 10 cm and a length of 20 cm.

### Example 17

A group of column-shaped hollow copper rods with different cross-sections were prepared as three-dimensional templates, wherein the cross-sectional shapes of the hollow copper rods included triangle, square and cylinder (FIG. 32). This group of column-shaped templates were selected as the collecting substrates for electrospinning. The other parameters were the same as those in Example 1. Three-dimensional electrospinning fiber tubular materials, having similar structures to those of the substrates and different cross-sectional shapes, were collected in this process, wherein the tube length was 2 cm.

### Example 18

A hollow cylindrical copper rod was prepared as a removable three-dimensional collecting template, wherein the diameter of the template was 3 mm, and the thickness of the tube was 1 mm. Another hollow cylindrical copper rod with a hole (having a size compatible with the above template) closed at one end was prepared as a fixed collecting template, wherein the diameter of the template was 4 mm. These two templates were assembled at an intersecting angle of 30° to form a disassemble three-dimensional combined collecting template. This combined template was selected as the collecting substrate for electrospinning. The other parameters were the same as those in Example 1. The specific steps for moving and removing the electrospinning fiber tubular material were the same as those in Example 9. A three-dimensional electrospun fiber material, having a similar structure to that of the substrate and Y-shaped intersecting channels, was collected in this process (FIG. 33).

### Example 19

A three-dimensional hollow combined collecting template was prepared for batch production, wherein each individual template was a hollow cylindrical three-dimensional template with a diameter of 0.5 mm, a height of 2 cm and a tube thickness of 0.2 mm. Nine identical individual templates were immobilized on an insulating plate, wherein the space between the templates was 4 cm. The other parameters were the same as those in Example 1. Nine three-dimensional electrospinning fiber tubular materials, each having a similar structure to that of the substrate, were collected in this process. The tubes had a diameter of 0.5 mm and a length of 1.5 cm.

### Example 20

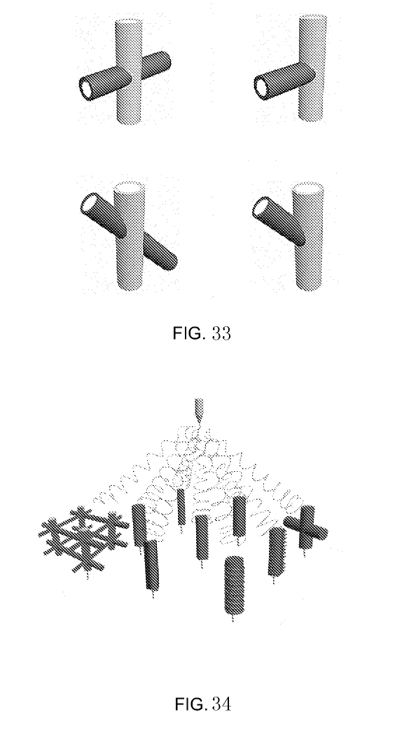

A three-dimensional hollow combined collecting template was prepared for batch production, wherein the individual templates were single collecting templates having different macro-structures and micro-morphologies and disassemble collecting templates having intersecting structure(cross structure)s respectively. Nine individual templates were immobilized on an insulating plate, wherein the space between the templates was 4 cm. The other parameters were the same as those in Example 16. Nine organic/inorganic composite tubular fiber materials, each having a similar structure to that of its substrate, were collected in this process (FIG. 34). Each single tube had a diameter (circumcircle diameter) of 10 cm and a length of 20 cm.

1. A process for preparing electrospun fiber tubular material, comprising the following steps:
(1) Formulating a solution or melt for the electrospinning process;
(2) Loading the solution or melt into an electrospinning fluid supplying unit;
(3) Immobilizing one or more metal rod templates or a metal rod combined-template on an auxiliary planar substrate as a collecting unit, or directly using one or more metal rod templates or a metal rod combined-template as a collecting unit;
(4) Controlling the flow rate of the electrospinning solution or melt in the range of 0.1-300 ml/h controlling the distance between the electrospinneret used as the high-voltage terminal and the collecting unit in the range of 1-100 cm, and controlling the voltage provided by the high voltage generator during electrospinning process in the range of 1-80 kv;
(5) Collecting the electrospun fiber tubular material on the metal rod templates or the metal rod combined-template of step (3) and removing it therefrom.

2. The process of claim 1 for preparing electrospun fiber tubular material, wherein the metal rod template or the metal rod combined-template is a single metal rod template or a two-dimensional or three-dimensional metal rod combined-template having an intersecting structure(cross structure) which is formed by combining the single metal rod templates.

3. The process of claim 2 for preparing electrospun fiber tubular material, wherein the intersecting angel in the intersecting structure(cross structure) lies between 10°-90°, and more than two single metal rod templates are combined.

4. The process of claim 2 for preparing electrospun fiber tubular material, wherein the metal material used in the single metal rod template is copper, iron, aluminum or alloys thereof.

5. The process of claim 2 for preparing electrospun fiber tubular material, wherein the single metal rod template is column-shaped or noncolumn-shaped or a combination thereof.

6. The process of claim 2 for preparing electrospun fiber tubular material, wherein the length of the single metal rod template is in the range of 0.5-50 cm.

7. The process of claim 2 for preparing electrospun fiber tubular material, wherein the cross-sectional shape of the single metal rod template is any regular or irregular shape.

8. The process of claim 7 for preparing electrospun fiber tubular material, wherein the regular cross-sectional shape of the single metal rod template is triangle, square, rectangle, pentacle or circle.

9. The process of claim 2 for preparing electrospun fiber tubular material, wherein the single metal rod template has a solid or hollow structure.

10. The process of claim 2 for preparing electrospun fiber tubular material, wherein the size of the cross-section of the single metal rod template is in the range of 0.005-30 cm as caculated based on the circumcircle diameter of the cross-section.

11. The process of claim 2 for preparing electrospun fiber tubular material, wherein the surface of the single metal rod template is a grid collecting structure or a protrusion collecting structure.

12. The process of claim 11 for preparing electrospun fiber tubular material, wherein the grid collecting structure is formed by woven grid wires of various radial sizes using various weaving methods, wherein the radial size of the grid wires is in the range of 0.1 mm-5 mm, the space between the grid wires is in the range of 10 μm-1000 μm, and the grid is woven by single weaving or double weaving.

13. The process of claim 11 for preparing electrospun fiber tubular material, wherein the raised portion of the raised collecting structure comprises protrusions on the surface of the single metal rod template, wherein the height of the protrusions is in the range of 10 μm-5000 μm.

14. The process of claim 13 for preparing electrospun fiber tubular material, wherein the raised portion forms a raised dot collecting template, a raised line collecting template or a raised dot-line combined collecting template.

15. An electrospun fiber tubular material prepared according to the process of claim 1 for preparing electrospinning fiber tubular material, wherein in terms of its contour, the material is a single tubular fiber material or a two-dimensional or three-dimensional tubular fiber material having a structure of communicating and intersecting channels.

16. The electrospinning fiber tubular material of claim 15, wherein the intersecting angel lies between 10°-90°.

17. The electrospun fiber tubular material of claim 15, wherein the single tubular fiber material is a polymeric, inorganic or composite material.

18. The electrospun fiber tubular material of claim 15, wherein the single tubular fiber material has a shape of column-shaped channel, non-column-shaped channel or a combination of column-shaped and non-column-shaped channel.

19. The electrospun fiber tubular material of claim 15, wherein the single tubular fiber material has a length in the range of 0.5-50 cm.

20. The electrospun fiber tubular material of claim 15, wherein the cross-sectional shape of the single tubular fiber material is any regular or irregular shape.

21. The electrospun fiber tubular material of claim 15, wherein the surface morphology of the single tubular fiber material is a random non-woven structure or a particularly patterned micro-morphology.
